(19) United States
(12) Patent Application Publication
(10) Pub. No.: US 2002/0077154 A1
(43) Pub. Date: Jun. 20, 2002

(54) Base station antenna sharing

(76) Inventors: Bruce A. Judson, San Luis Obispo, CA (US); Roman G. Boychew, Lemon Grove, CA (US)

Correspondence Address: Qualcomm Incorporated, Patents Department, 5775 Morehouse Drive, San Diego, CA, 92121-1714, US

(21) Appl. No.: 09/741,527

(22) Filed: Dec. 19, 2000

(51) Int. Cl. H04M 1/00

(52) U.S. Cl. 455/562; 455/561

(57) ABSTRACT

Methods and apparati for sharing antennas among a plurality of receivers or transceivers are disclosed. A communications signal received at an antenna is filtered, pre-amplified and then communicated to antenna sharing equipment. The signal is split in the antenna sharing equipment into two or more signals containing the same information as the original signal but having a lower signal power than the original signal. The two or more signals are communicated to two or more receivers or transceivers for demodulation and further signal processing. The antennas may be coupled to the transceivers via a directive coupler so that communications signals generated by the transceivers are transmitted by the antennas as well.

### BACKGROUND

I. Field of the Invention

The present invention relates to wireless communication devices in general, and to a system and method for sharing antennas among base station transceivers in particular.

II. Description

Communication systems have been developed to allow transmission of information signals from a base station location to a physically distinct user or subscriber location. Both analog and digital methods have been used to transmit such information signals over communication channels linking the base station and user locations. Digital methods tend to afford several advantages relative to analog techniques, including for example, improved immunity to channel noise and interference, increased capacity and improved security of communication through the use of encryption.

In transmitting an information signal in either direction over a communication channel, the information signal is first converted into a form suitable for efficient transmission over the channel. Conversion, or modulation, of the information signal involves varying a parameter of a carrier wave on the basis of the information signal in such a way that the spectrum of the resulting modulated carrier is confined within the channel bandwidth. At the recipient location the original message signal is replicated from a version of the modulated carrier received subsequent to propagation over the channel. Such replication is generally achieved by using an inverse of the modulation process employed during message transmission.

Modulation facilitates multiplexing, i.e., the simultaneous transmission of several signals over a common channel. Multiplexed communication systems will generally include a plurality of remote subscriber units requiring intermittent service rather than continuous access to the communication channel. Systems designed to enable communication with a selected subset of a full set of subscriber units have been termed multiple access communication systems.

A particular type of multiple access communications system, known as a code division multiple access (CDMA) modulation system, may be realized in accordance with spread spectrum techniques. In spread spectrum systems, the modulation technique utilized results in spreading of the transmitted signal over a wide frequency band within the communication channel. Other multiple access communication system techniques include, for example, time division multiple access (TDMA) and frequency division multiple access (FDMA). CDMA techniques however, offer significant advantages over other multiple access communication system techniques. The use of CDMA techniques in a multiple access communication system is disclosed in U.S. Pat. No. 4,901,307, issued Feb. 13, 1990, entitled “SPREAD SPECTRUM MULTIPLE ACCESS COMMUNICATION SYSTEM USING SATELLITE OR TERRESTRIAL REPEATERS,” assigned to the assignee of the present invention and incorporated herein by reference.

In the above referenced U.S. Pat. No. 4,901,307, a multiple access technique is disclosed where a large number of mobile system users each having a transceiver communicate through satellite repeaters or terrestrial base stations using CDMA spread spectrum communication signals. CDMA modulation in turn allows the frequency spectrum dedicated to cellular telephony to be reused multiple times, resulting in a significant increase in system user capacity. In fact, the same frequency band is used in each cell within the cellular geographic serving area (CGSA) of the CDMA system (assuming the cell has not been subdivided into sectors). Thus, the use of CDMA results in a much higher spectral efficiency than can be achieved using other multiple access techniques.

An exemplary cellular system is depicted in FIG. 1A. Such systems generally include a plurality of mobile subscriber units 10, a plurality of base stations 12, a base station controller (BSC) 14, and a mobile switching center (MSC) 16. The MSC 16 is configured to interface with a conventional public switch telephone network (PSTN) 18. The MSC 16 is also configured to interface with the BSC 14. The BSC 14 is coupled to each base station 12. The base stations 12 may also be known as base station transceiver subsystems (BTSs) 12. Alternatively, “base station” may refer collectively to a BSC 14 and one or more BTSs 12, BTSs 12 may be referred to as “cell sites” 12, or sectors of a given BTS 12 may be referred to as cell sites. The mobile subscriber units 10 are typically cellular telephones 10, and the cellular telephone system is advantageously a spread spectrum CDMA system configured for use in accordance with the IS-95 standard.

During typical operation of the cellular telephone system, the base stations 12 receive sets of reverse link signals from sets of mobile units 10. The mobile units 10 are conducting telephone calls or other communications. Each reverse link signal received by a given base station 12 is processed within that base station 12. The resulting data is forwarded to the BSC 14. The BSC 14 provides call resource allocation and mobility management functionality, including the orchestration of soft handoffs between base stations 12. The BSC 14 also routes the received data to the MSC 16, which provides additional routing services for interface with the PSTN 18. Similarly, the PSTN 18 interfaces with the MSC 16 and the MSC 16 interfaces with the BSC 14, which in turn controls the base stations 12 sets of forward link signals to sets of mobile units 10.

In North America, the frequency spectrum available for cellular communications comprises the RF bandwidth 824-894 MHz, while the frequency spectrum available for PCS communications comprises the RF bandwidth 1850-1990 MHz. Within each of the foregoing bandwidths there are three operational frequency bands typically referred to as frequency band A, B and C. A cellular or PCS carrier obtains rights from to use a particular band, for example frequency band A. Within each band there are multiple operational channels from which to choose from. Selection of a particular channel is referred to as selection of a frequency assignment. Each channel or frequency assignment is further subdivided into bandwidths dedicated to forward link communications and reverse link communications.

For a particular cellular CDMA system, communication between a base station and subscriber units within the surrounding cell region is achieved by spreading each transmitted signal over the available channel bandwidth through the use of a high speed pseudonoise code (PN) code. Transmitter stations use different PN codes or PN codes that are offset in time to produce signals that can be received simultaneously but separated from one another through use of replica PN codes. The high speed PN code modulation also allows a receiving station to receive and discriminate among signals from a single transmitting station that have traveled over several distinct propagation paths.

A signal having traveled several distinct propagation paths is generated by the multipath characteristics of the cellular channel. One characteristic of a multipath channel is the time spread introduced in a signal that is transmitted through the channel. For example, an ideal impulse transmitted over a multipath channel will appear as a stream of pulses to the recipient of the impulse. Another characteristic of a multipath channel is that each path through the channel may be characterized by a different attenuation factor. For example, an ideal impulse transmitted over a multipath channel will appear as a stream of pulses, each of which will generally have a different signal to noise ratio (SNR).

In a mobile radio channel, multipath propagation is created by reflection of the signal from obstacles in the environment such as buildings, trees, cars and the like. In general, the mobile radio channel is a time varying multipath channel due in part to the relative motion of the structures that create the multipath environment. In other words, the stream of pulses that would be received following the transmission of an ideal pulse over a mobile radio channel would change in time location, attenuation and phase would vary depending on when the ideal pulse were transmitted.

In narrow band modulation systems, such as the FM modulation employed in many conventional radio telephone systems, the multipath characteristics of a mobile radio channel often result in severe signal fading. Fading is the result of the time delays introduced by the multipath environment, and occurs when multipath signals are phase shifted to such a degree that destructive interference with one another occurs. As noted above though, in CDMA receivers can discriminate between multipath transmissions through the use of the PN codes. This ability to discriminate between multipath signal transmissions in CDMA systems reduces the severity of signal fading in such systems. Indeed, the ability to discriminate between multipath signal transmissions actually provides significant advantages in CDMA systems.

The existence of multipath signal transmissions or path diversity and the ability to discriminate between the various paths traveled may be exploited in CDMA systems through the use of diversity receivers to actually improve the SNR of received signals. Because each signal transmission in a CDMA system is modulated with a PN code whose speed (i.e., chip rate) is generally many times that of the information signal, two or more signals arriving at a receiver via different paths may be separately demodulated, time aligned and used to create a composite received signal when the two or more signals have greater than chip time (i.e., the duration of one data bit of the PN code) differential path delay. Each multipath signal typically exhibits independent fading characteristics and, therefore, a complete signal loss will occur only when all of the multipath signals fade simultaneously. Thus, diversity combining of multipath signals significantly increases both the quality and reliability of communications in CDMA systems.

The benefits of diversity combining of multipath signals may be further enhanced through the use of a form of maximal ratio combining of the received signals. The SNR of each multipath signal arriving at the receiver is determined independently, and then a composite is formed by adding together the individually demodulated multipath signals according to the weighted average of their individual SNRs.

As mentioned above, unlike cellular systems employing narrow band modulation techniques each cell in a CDMA system CGSA utilizes the same portion of the frequency spectrum for both forward and reverse link communications. This feature of CDMA systems results in a significant increase in system user capacity and a much higher spectral efficiency vis-a-vis other multiple access systems. System user capacity and spectral efficiency can be further enhanced by subdividing individual cells into sectors. In the typical sectorized cell, each sector will have a dedicated base station transceiver subsystem (BTS) as well as dedicated transmission and reception antennas. If the BTS has diversity combining capabilities, at least one additional antenna will also be necessary for the reception of multipath signal transmissions. Adaptive sectorization also may be employed in each cell as described in U.S. Pat. No. 5,621,752 entitled “ADAPTIVE SECTORIZATION IN A SPREAD SPECTRUM COMMUNICATION SYSTEM,” assigned to the assignee of the present invention and incorporated herein by reference. The BTS in each sector then communicates with mobile stations within that sector via the same forward and reverse link communication frequency channels that otherwise would have been utilized for the entire geographic coverage area of the cell. It can therefore be appreciated that subdividing cells into sectors results in further increases in user capacity and spectral efficiency.

The division of individual cells into sectors also results in further opportunities to enhance the quality and reliability of communications within the CDMA system by providing additional opportunities for diversity combining. As in the case of non-sectorized cells where a mobile unit may simultaneously communicate with the BTSs of more than one cell, in a sectorized cell a mobile unit may simultaneously communicate with the BTSs of more than one sector in the cell. This results in an even larger number of multipath signals being available for the maximal ratio combining described above. In other words, the signal transmitted by a mobile and received by the BTSs of the multiple cell site sectors can be individually demodulated by the BTS for each sector and combined according to the weighted average of the SNR for each demodulated signal of each BTS sector.

In a three-sector two-frequency assignment cell site, a single three sector transceiver (TST) typically provides control, monitoring, transmit, receive and test functions for a single frequency assignment and up to three geographic sectors in a base station. Thus, for a three-sector two-frequency assignment cell site there normally will be two TSTs within the BTS for that cell site. FIG. 1B shows a functional block diagram of the elements in a three-sector two-frequency assignment BTS without the present antenna sharing invention. TST 101 provides the functions outlined above for sectors α,β and δ in frequency assignment 1 (FA1) while TST 102 provides the same functions for sectors α,β and δ in frequency assignment 2 (FA2). TSTs 101 and 102 are each coupled to driver modules α1,β1 and γ1 103 and α2,β2 and γ2 104 respectively, and then to demarcation panel 105. Demarcation panel 105 is coupled to RF Front Ends α1, β1 and γ1 106 and α2, β2 and γ2 107. Each RF Front End α1,β1 and γ1 106 and α2,β2 and γ2 107 is coupled to two of the directional antennas 108-119. Using FAl in sector α as an example, antenna 108 is used to both transmit and receive RF signals Tx 120 and Rx0 121 in sector α on FA1, while antenna 109 is used solely for obtaining diversity receive signal Rx1 122 in sector α on FA1. Antenna 108 may be used for both transmission and reception of RF signals in sector α on FA1 through the use of a diplexer (not shown). The diplexer acts as a directive coupler, allowing signal Tx 120 to pass but preventing it from backwashing to the receiver portion of TST 101, which would desensitize TST 101 to and impair the reception of signals Rx0 121 and Rx1 122.

It can therefore be appreciated that as the number of sectors in a base station and the number of multipath signals combined per user rise, there is an appreciable proliferation of the number of antennas at each BTS as well. Thus, there is a need for a simple way of retaining the benefits realized through increased sectorization and diversity combining that minimizes the number of antennas employed in each sector of the cell site.

### SUMMARY

The present invention is directed to a method and apparatus for minimizing the number of dedicated antennas employed in a cell site. The invention comprises a method for sharing antennas among a plurality of communications components comprising the receipt of a first communications signal at an antenna, splitting the first signal into second and third signals, and distributing the second signal to a first communications component and the third signal to a second communications component. The invention may also reside in a wireless communications base station comprising a plurality of directional antennas, a plurality of receivers, and antenna equipment operatively connected to the antennas and receivers for sharing a communications signal received by one of the antennas among at least two of the receivers.

### BRIEF DESCRIPTION OF THE DRAWINGS

The features, objects and advantages of the present invention will become more apparent from the detailed description set forth below when take in conjunction with the drawings, in which like reference characters identify correspondingly throughout and wherein:

FIG. 1A is a diagram of an exemplary cellular system.

FIG. 1B shows a block diagram of a prior art 3-sector 2-frequency assignment BTS arrangement.

FIG. 2 illustrates a 3-sector 2-frequency assignment antenna beamwidth in accordance with a preferred embodiment of the invention.

FIG. 3 shows the connectivity of one sector in the 3-sector 2-frequency assignment cell site illustrated in FIG. 2.

FIG. 4 shows a block diagram of the reverse link portion of the antenna sharing equipment shown in FIG. 3.

FIG. 5A is a lumped element circuitry diagram of the Wilkinson splitter shown in FIG. 5 in accordance with a preferred embodiment of the invention.

FIG. 5B is an illustration of the transmission line implementation of the Wilkinson splitter shown in FIG. 5A in accordance with a preferred embodiment of the invention.

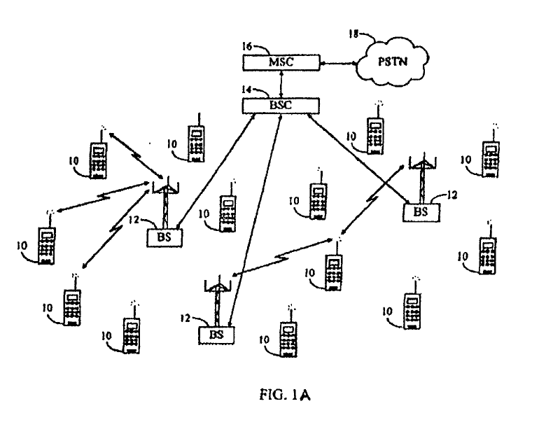

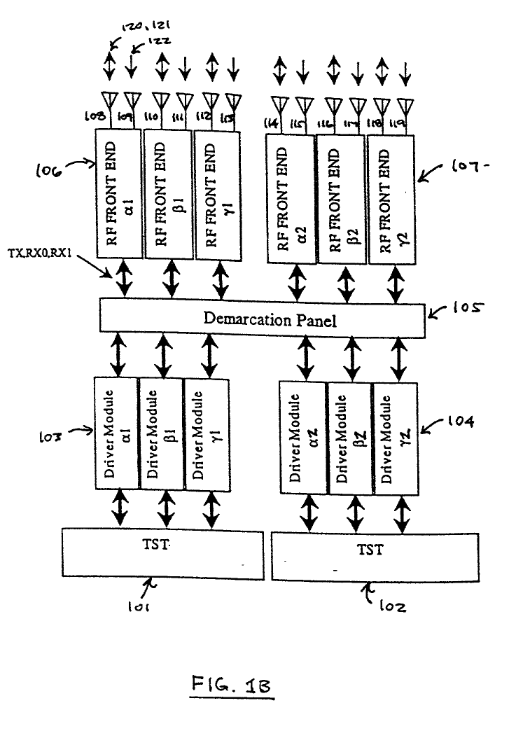

### DETAILED DESCRIPTION

As will be understood by those having ordinary skill in the art, various methods and apparati for sharing antennas within a BTS embodying features of the present invention may reside in any wireless communication system, such as cellular systems, wireless local loop telephone (WLL) systems, and the like. Cellular systems include, by way of example only, AMPS (analog), IS-54 (North American TDMA), GSM (worldwide TDMA), and IS-95 (North American CDMA). In a preferred embodiment, the cellular system is a spread spectrum CDMA cellular telephone system operating at 1900 MHz (i.e, personal communication system (PCS)).

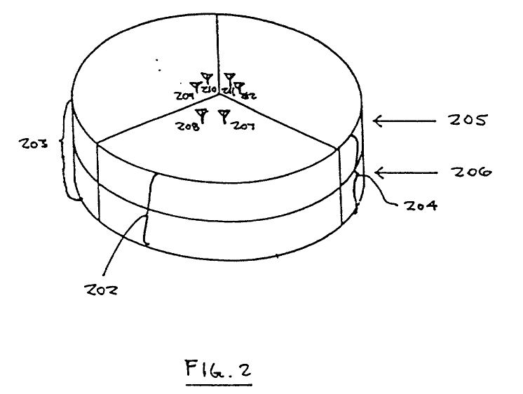

The goal of antenna sharing is to reduce the total number of antennas installed at a cell site and system-wide. The invention achieves this goal, among others, by sharing an RF signal received at a single antenna among a plurality of receivers and/or transceivers. In preferred embodiments of the invention, two BTS transceivers in a sectorized cell site should be assigned to neighboring frequency assignments in the same sector of the cell site. In one preferred embodiment of the invention, a single module allows 2 TSTs in a 3-sector 2-frequency assignment BTS to employ 2 antennas for 6 RF signals—a transmit signal in sector 1 on FA1, a transmit signal in sector 1 on FA2, 2 receive signals in sector 1 on FA1, and 2 receive signals in sector 1 on FA2. FIG. 2 illustrates a 3-sector 2-frequency assignment antenna beamwidth 201 in accordance with a preferred embodiment of the invention. Each of the sectors α 202, β203 and γ204 cover approximately 120 degrees of the cell site radially and have two distinct but neighboring frequency assignments FA1 205 and FA2 206 for communications with mobile units (not shown) within area covered by the cell site. Each of the sectors 202-204 of the cell site have two directional antennas 207-212 dedicated to communications within that sector. For example, sector α 202 has directional antennas 207 and 208 that provide the link between the cell site BTS and the mobile units in the coverage area of sector α202.

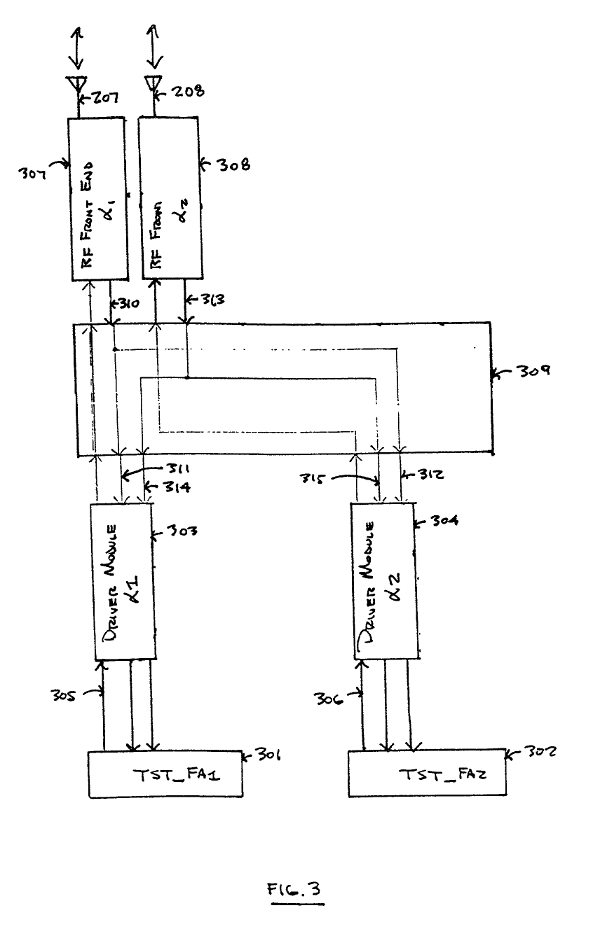

Referring now to FIG. 3, there is shown the connectivity of sector α 202 in FIG. 2 to the BTS for a 3-sector 2-frequency assignment cell site in accordance with a preferred embodiment of the invention. TST_FA1 301 provides control, monitoring, transmit, receive and test functions for sector α202 on FA1 205, while TST_FA2 302 provides the same functions for sector α202 on FA2 206. TST_FAL 301 and TST_FA2 302 are coupled to driver module α1 303 and driver module α2 304 respectively. In the forward link, driver module α1 303 receives RF signal Tx_FA1 305 from TST 301, amplifies that signal and passes it to RF front end α1 307 via antenna sharing equipment 309. RF front end α1 307 further amplifies and filters Tx_FA1 305 before directional antenna 207 radiates the signal to a mobile user (not shown) located in sector α202 and assigned to FA1 205. Similarly, driver module α2 304 receives RF signal Tx_FA2 306 from TST 302, amplifies that signal and passes it to RF front end α2 308 via antenna sharing equipment 309. RF front end α2 308 further amplifies and filters Tx_FA2 306 before directional antenna 208 radiates the signal to a mobile user (not shown) located in sector α202 and assigned to FA2 206.

Referring still to FIG. 3, in the reverse link directional antenna 207 receives RF signal Rx_α1 310 from mobile users in sector α202. Following pre-amplification and filtering in RF Front End α1 307, Rx_α1 310 is output to antenna sharing equipment 309 where it is split into RF signals Rx0_FA1 311 and Rx0_FA2 312. Rx0_FA1 311 and Rx0_FA2 312 are then output to driver modules α1 303 and α2 304 respectively, which compensate for any cable losses that have occurred. Rx0_FA1 311 and Rx0_FA2 312 are subsequently presented to TST_FA1 301 and TST_FA2 302 respectively for processing. In like manner, directional antenna 208 receives RF signal Rx_α2 313 from mobile users in sector α202. Following pre-amplification and filtering in RF Front End α2 304, Rx_α2 313 is output to antenna sharing equipment 309 where it is split into RF signals Rx1_FA1 314 and Rx1_FA2 315. Rx1_FA1 314 and Rxl_FA2 315 are then output to driver modules α1 303 and α2 304 respectively, which compensate for any cable losses that have occurred. Rx1_FA1 314 and Rx1_FA2 315 are subsequently presented to TST_FA1 301 and TST_FA2 302 respectively for processing. Thus, the transceivers for each frequency assignment in sector α receive 2 reverse link signals while employing only 1 directional antenna for each RF front end. TST_FA1 301 receives reverse link signals Rx0_FA1 311 from directional antenna 307 (coupled to RF Front End α1 307) and Rx1_FA1 314 from directional antenna 308 (coupled to RF Front End α2 304), and TST_FA2 302 receives reverse link signals, Rx0_FA2 312 from directional antenna 307 and Rx1_FA2 315 from directional antenna 308.

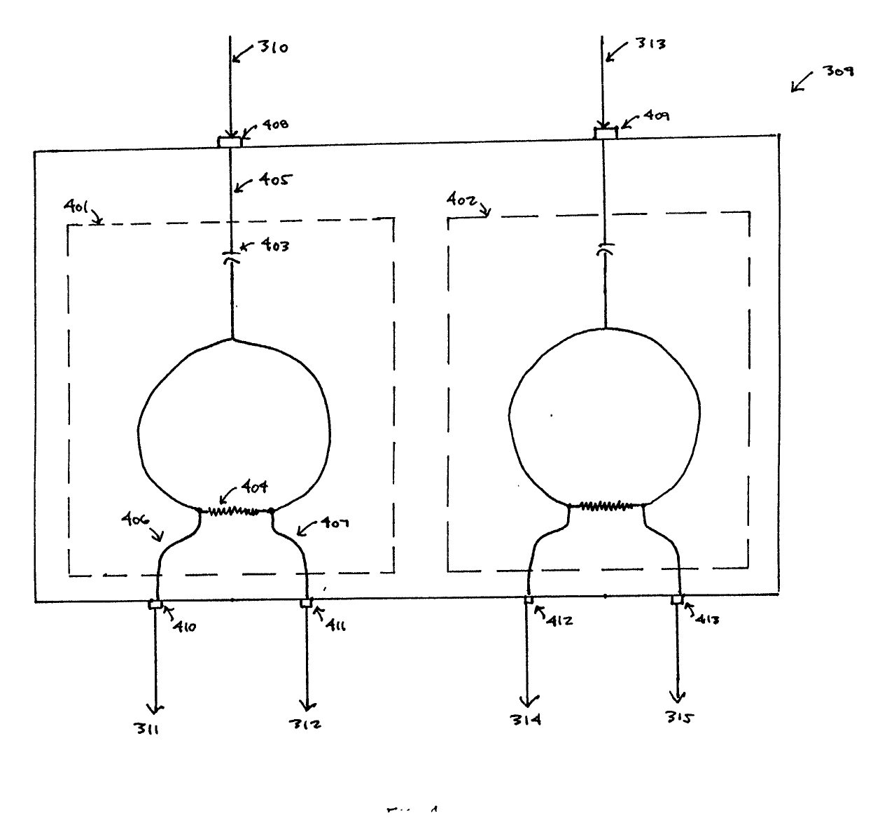

Referring now to FIG. 4, there is shown a block diagram of the reverse link portion of antenna sharing equipment 309 of FIG. 3. The reverse link portion of antenna sharing equipment 309 comprises two Wilkinson splitters 401 and 402, as well as the various electrical connections 408-413 for receiving signals 310 and 311 and outputting signals 311-312 and 314-315. The signal path and operation of antenna sharing equipment 309 for reverse link signals 310 and 313 are identical. Therefore, only a description of the path traveled by signal 310 will be undertaken. Following pre-amplification and filtering in RF Front End α1 307, RF signal Rx_α1 310 is routed to electrical connection 408 of antenna sharing equipment 309. In a preferred embodiment of the invention, RF Front End α1 307 resides outside the cell site BTS in close proximity to directional antennas 207 and 208, and RF signal Rx_α1 310 is therefore routed to antenna sharing equipment 309 via coaxial cable. In this case electrical connection 408 is an N-type female coaxial cable connector. One having skill in the art will appreciate though that many other means of routing electrical signals, and organizing and connecting the various electrical components may be utilized in the invention without the exercise of inventive skill or faculty. Signal Rx_α1 310 is then routed to Wilkinson splitter 401 where it is split into RF signals 406 and 407. Signal 406 is then output as RF signal Rx0_FA1 311 via electrical connection 410, and signal 407 is output as RF signal Rx0_FA2 312 via electrical connection 411. Signals Rx0_FA1 311 and Rx0_FA2 312 carry the same information as that contained in Rx_α1 310, but now have approximately one-half the power of signal Rx0_FA1 311. Capacitor 403 isolates circuit 401 from unwanted transient electrical signals and electromagnetic interference. Resistor 404 provides balance between the two branches or signal paths 406-407 of circuit 401. Signal Rx_α1 310 also may be amplified before it is split into signals Rx0_FA1 311 and Rx0_FA2 312 to compensate for the reduction in signal power. Preferably, a low noise amplifier such as an operational amplifier as known in the art should be used.

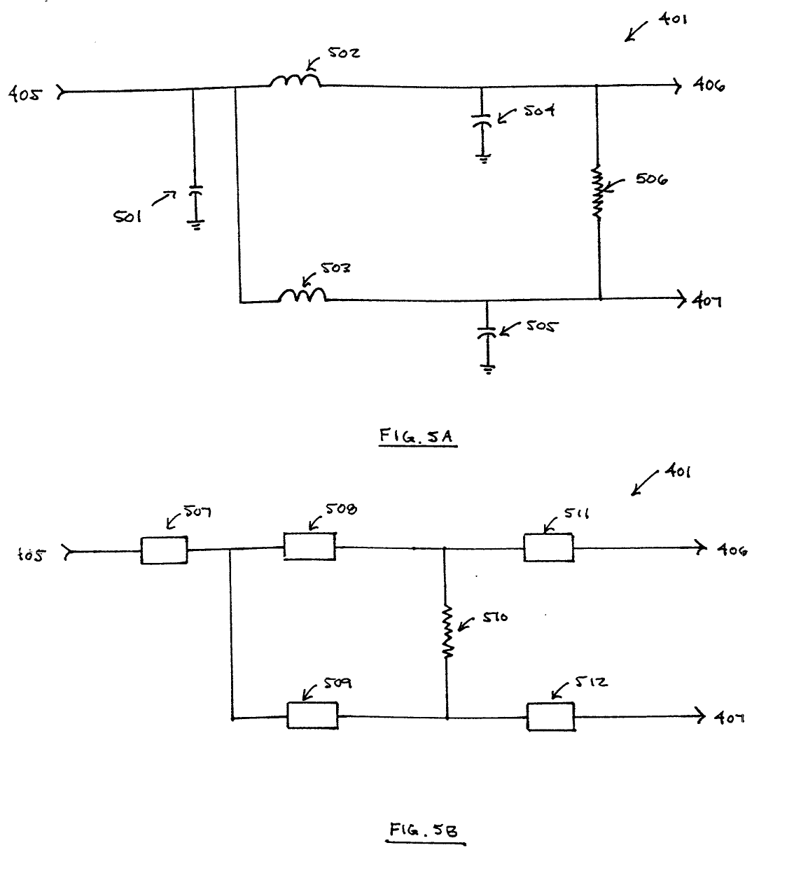

Referring now to FIG. 5A, there is shown a lumped element circuit diagram of Wilkinson splitter 401 in accordance with a preferred embodiment of the invention. An ideal Wilkinson splitter provides perfect isolation between the output signals at the designed center frequency (F₀), and its symmetry provides excellent signal amplitude and phase balance between the output signals. For PCS systems, the frequency band of interest comprises 1850 MHz to 1990 MHz. The Wilkinson splitter 401 shown in FIG. 5A was therefore designed around a center frequency of 1920 MHz for utilization in a PCS cell site. Capacitor 501 corresponds to capacitor 403 in FIG. 4 and has a value of 2.54 pF. Inductors 502 and 503 both have values of 5.86 nH. Capacitors 504 and 505 both have values of 1.17 pF. Resistor 506 corresponds to resistor 404 in FIG. 4 and has a value of 100 ohms.

Referring now to FIG. 5B, there is shown a transmission line implementation of the lumped element circuit diagram shown in FIG. 5A. With a printed circuit board material having a thickness of 20 mil, a 1 ounce copper thickness of 1.5 mil, a dielectric constant of 3.0 and a loss tangent of 0.0013, the 50 ohm trace width is 48 mil, and the quarter wavelength L_{d} is 1144 mil. Line 507 has an impedance of 50 ohms and a phase angle of 52.16 degrees. Lines 508 and 509 each have an impedance of 70.96 ohms at a phase angle of 101.06 degrees. Resistor 510 has a value of 100 ohms. Lines 511 and 512 each have an impedance of 50 ohms and a phase angle of 92.77 degrees. Simulations of the foregoing embodiment of Wilkinson splitter 401 show a return loss of 9 db when operated in the frequency range of 1850-1990 MHz. Independent of particular embodiments of the invention though, there will always be some amount of signal power loss introduced to the reverse link signals from the splitting of the various signals. These power losses may be compensated by limiting the distance reverse link signals must travel from antenna to TST. For instance, where the RF front ends for the BTS reside on the pole or in otherwise close proximity to the antennas, the antenna sharing equipment resides on or in close proximity to the BTS itself, and coaxial cable is employed to connect the foregoing components to one another, limiting the distance of the coaxial cable runs is one method of preventing excessive reverse link signal power losses. When employing the preferred embodiments of the invention illustrated in FIGS. 4-5B and connecting RF Front Ends 307-308 to antenna sharing equipment 309 with coaxial cable, the cable runs from RF Front Ends 307-308 to antenna sharing equipment 309 should be limited such that no more than a 7.2 dB power loss occurs in each reverse link signal path.

One having skill in the art will readily appreciate from the foregoing description that the preferred embodiment of the invention results in a reduction by one-half of the number of antennas that must be employed in a 3-sector 2-frequency assignment cell site utilizing two TSTs. The invention may however be utilized in any cell-site configuration utilizing multiple frequency assignments in a sector. For instance, and by way of example only, the invention may be utilized to share antennas in a 1-sector 2 frequency assignment cell site, a 2-sector 2-frequency assignment cell site, or a 6-sector 2-frequency assignment cell site. It should be noted though that the invention is not limited to 2-frequency assignment cell site antenna sharing. Nor is the invention limited to antenna sharing between 2 independent and distinct TSTs, but may be employed in conjunction with multicarrier transceivers as well.

The previous description of the preferred embodiments is provided to enable any person skilled in the art to make or use the present invention. The various modifications to these embodiments will be readily apparent to those skilled in the art, and the generic principles defined herein may be applied to other embodiments without the use of inventive faculty. Thus, the present invention is not intended to be limited to the embodiments shown herein but is to be accorded the widest scope consistent with the principles and novel features disclosed herein.

That which is claimed is:

1. A method of sharing antennas among a plurality of communications components, comprising the steps of:
(A) receiving a first communications signal at an antenna;
(B) splitting said first signal into second and third signals; and
(C) distributing said second signal to a first communications component and said third signal to a second communications component.

2. The method of claim 1, wherein said antenna comprises a base station antenna.

3. The method of claim 1, wherein said antenna comprises a directional antenna.

4. The method of claim 1, wherein said first signal is split with a Wilkinson splitter.

5. The method of claim 4, wherein said Wilkinson splitter has a design center frequency in the range of approximately 824-894 MHz.

6. The method of claim 5, wherein said frequency is approximately 859 MHz.

7. The method of claim 4, wherein said Wilkinson splitter has a design center frequency in the range of approximately 1850-1990 MHz.

8. The method of claim 7, wherein said frequency is approximately 1920 MHz.

9. The method of claim 8, wherein said Wilkinson splitter has a characteristic impedance of approximately 50 ohms and a quarter wavelength arm length of approximately 1144 mil.

10. The method of claim 4, wherein said Wilkinson splitter comprises a printed circuit board.

11. The method of claim 1, wherein said communications components comprise transceivers.

12. The method of claim 1, wherein said communications components comprise three sector base station transceivers.

13. The method of claim 1, wherein said communications components comprise a multicarrier transceiver.

14. The method of claim 1, wherein said first signal comprises a wireless communications signal.

15. The method of claim 1, wherein said first signal comprises a CDMA modulated signal.

16. The method of claim 1, wherein said first communications component is dedicated to a first frequency assignment and said second communications component is dedicated to a second frequency assignment.

17. The method of claim 1, wherein said antenna is utilized by said first communications component to transmit a fourth communications signal.

18. The method of claim 1, comprising the additional step of amplifying said first signal prior to said splitting.

19. The method of claim 18, wherein said first signal is amplified with a low noise amplifier.

20. A wireless communications base station, comprising:
(A) a plurality of directional antennas;
(B) a plurality of receivers; and
(C) antenna equipment, operatively connected to said antennas and said receivers, for sharing a communications signal received by one of said antennas among at least two of said receivers.

21. The base station of claim 20, wherein said receivers are dedicated to a plurality of frequency assignments.

22. The base of claim 21, wherein one of said at least two receivers is dedicated to a first frequency assignment and another of said at least two receivers is dedicated to a second frequency assignment.

23. The base station of claim 20 wherein said antenna equipment splits said communications signal into a plurality of signals.

24. The base station of claim 20, wherein said antenna equipment comprises a plurality of Wilkinson splitters.

25. The method of claim 24, wherein said Wilkinson splitter has a design center frequency in the range of approximately 824-894 MHz.

26. The method of claim 25, wherein said frequency is approximately 859 MHz.

27. The method of claim 24, wherein said Wilkinson splitter has a design center frequency in the range of approximately 1850-1990 MHz.

28. The method of claim 27, wherein said frequency is approximately 1920 MHz.

29. The method of claim 28, wherein said Wilkinson splitter has a characteristic impedance of approximately 50 ohms and a quarter wavelength arm length of approximately 1144 mil.

30. The method of claim 24, wherein said Wilkinson splitter comprises a printed circuit board.

31. The base station of claim 20 wherein power losses to said communications signal as a result of said sharing are controlled by limiting the distance said signal travels from said antennas to said antenna equipment.

32. The base station of claim 31 wherein said communications signal loses no more than 7.2 dB from said antennas to said antenna equipment.

33. The base station of claim 20 wherein said communications signal is a CDMA modulated signal.

34. The base station of claim 20 wherein said receivers comprise transceivers.

35. The base station of claim 34 wherein the operative connection between said antennas and said antenna equipment includes a directive coupler, said coupler allowing a communications signal generated by one of said transceivers to be transmitted by one of said antennas.

36. The base station of claim 34 wherein said transceivers comprise three sector transceivers.

37. The base station of claim 20 wherein the operative connection between said antennas and said antenna equipment includes means for amplifying said signal.

38. The base station of claim 37 wherein said means for amplifying comprises a low noise amplifier.

39. The base station of claim 20 wherein said antennas are directional antennas.

40. A wireless communications base station comprising:
(A) means for receiving a first communications signal;
(B) means for splitting said first signal into second and third signals; and
(C) means for distributing said second signal to a first communications component and said third signal to a second communications component.

41. The base station of claim 40 wherein said means for receiving comprises an antenna.

42. The base station of claim 41 wherein said antenna comprises a directional antenna.

43. The base station of claim 40 wherein said means for splitting comprises a Wilkinson splitter.

44. The method of claim 43, wherein said Wilkinson splitter has a design center frequency in the range of approximately 824-894 MHz.

45. The method of claim 44, wherein said frequency is approximately 859 MHz.

46. The method of claim 43, wherein said Wilkinson splitter has a design center frequency in the range of approximately 1850-1990 MHz.

47. The method of claim 46, wherein said frequency is approximately 1920 MHz.

48. The method of claim 47, wherein said Wilkinson splitter has a characteristic impedance of approximately 50 ohms and a quarter wavelength arm length of approximately 1144 mil.

49. The method of claim 43, wherein said Wilkinson splitter comprises a printed circuit board.

50. The base station of claim 40 wherein said communications components comprise transceivers.

51. The base station of claim 40 further comprising a directive coupler operatively connected between said means for receiving and said means for splitting, said directive coupler allowing a fourth communications signal generated by said first transceiver to be transmitted by said means for receiving.

52. The base station of claim 40 wherein said communications components comprise three sector transceivers.

53. The base station of claim 40 wherein said communications components comprise a multicarrier transceiver.

54. The base station of claim 40 wherein said first communications signal comprises a wireless communications signal.

55. The base station of claim 40 wherein said first signal comprises a CDMA modulated signal.

56. The base station of claim 40 wherein said first communications component is dedicated to a first frequency assignment and said second communications component is dedicated to a second frequency assignment.

57. The base station of claim 40 further comprising means for amplifying said first signal prior to said splitting.
